(19) United States
(12) Patent Application Publication
(10) Pub. No.: US 2024/0143745 A1
(43) Pub. Date: May 2, 2024

(54) ARTIFICIAL INTELLIGENCE-ASSISTED SECURITY DATA EXPLORATION ON A FEDERATED SEARCH ENVIRONMENT

(71) Applicant: International Business Machines Corporation, Armonk, NY (US)

(72) Inventors: Sulakshan Vajipayajula, Alpharetta, GA (US); Jason David Keirstead, Fredericton (CA); Paul Coccoli, Marietta, GA (US)

(21) Appl. No.: 17/976,657

(22) Filed: Oct. 28, 2022

(51) Int. Cl. G06F 21/55

(52) U.S. Cl. CPC G06F 21/554; G06F 2221/034

(57) ABSTRACT

A computer-implemented method includes receiving CTI from a data source during a search of a system, and capturing the CTI in a STIX bundle. The method includes invoking an analytic pipeline on the STIX bundle that includes applying a classification model on the STIX bundle to classify features from the CTI and applying a clustering model on the STIX bundle to identify a cluster of features from the CTI. The output of the analytic pipeline is analyzed to identify suspicious features that include a combination of the classified features and the cluster of features. The suspicious features are annotated thereby highlighting risk and threat, and attack techniques are identified using existing domain expertise encoded as heuristics to provide additional machine learning features.

### BACKGROUND

The present invention relates to cybersecurity intelligence and analytics, and more specifically, this invention relates to artificial intelligence-assisted security data exploration on a federated search environment.

The identification of anomalous and/or suspicious behavior typically relies on searching a data source for known threats. There remains a need to identify focus areas to assist security analysts and threat hunters investigating security incidents. There is typically a delay in updating a model of current security threats while a search process is ongoing.

### SUMMARY

In one embodiment, a computer-implemented method includes receiving cyber threat information from a data source during a search of a system, and capturing the cyber threat information in a STIX bundle. Next, the method includes invoking an analytic pipeline on the STIX bundle where the analytic pipeline includes applying a classification model on the STIX bundle to classify features from the cyber threat information and applying a clustering model on the STIX bundle to identify a cluster of features from the cyber threat information. The output of the analytic pipeline is analyzed to identify suspicious features that include a combination of the classified features and the cluster of features. The suspicious features are annotated from the cyber threat information thereby highlighting risk and threat, and attack techniques are identified using existing domain expertise encoded as heuristics to provide additional machine learning features.

In another embodiment, a computer-implemented method for training a machine learning model to assist a search for suspicious features includes training a model according to a set of suspicious features identified according to suspicious behavior criteria. In addition, a second set of suspicious features are identified during a federated search of a system and/or a third set of suspicious features are identified during an incident investigation of a data source. The second and/or third set of suspicious features are applied to the model for training the model to identify the second and/or third set of suspicious features during data exploration. The method includes using the model trained with the set of suspicious features identified according to the behavior criteria, the second set of suspicious features, and/or the third set of suspicious features during data exploration for identifying suspicious features. In addition, the method includes repeating the operations of identifying sets of suspicious features and training the model therewith for training the model incrementally during the data exploration.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method for annotating suspicious features from federated searches using a machine learning model, in accordance with one embodiment of the present invention.

FIG. 4 is a schematic diagram of a system that describes an artificial intelligence-assisted security data exploration on federated search, in accordance with one embodiment of the present invention.

FIG. 5 is a flowchart of a method for training a machine learning model for to assist a threat analyst searching for suspicious behavior, in accordance with one embodiment of the present invention.

FIG. 6 is a schematic diagram of implementation of a method for training a machine learning model for annotating suspicious behavior, in accordance with one embodiment of the present invention.

FIG. 7 is a schematic diagram of a system using a ML model during data exploration in order to assist a security analyst identify and focus on security threats, in accordance with one embodiment of the present invention.

FIG. 8 is a schematic diagram of an example of the system, in accordance with one embodiment of the present invention.

FIG. 9 is an example of an incidence graph showing suspicious processes identified by the system, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for an artificial intelligence (AI)-assisted security data exploration on a federated search environment.

In one general embodiment, a computer-implemented method includes receiving cyber threat information from a data source during a search of a system, and capturing the cyber threat information in a STIX bundle. Next the method includes invoking an analytic pipeline on the STIX bundle where the analytic pipeline includes applying a classification model on the STIX bundle to classify features from the cyber threat information and applying a clustering model on the STIX bundle to identify a cluster of features from the cyber threat information. The output of the analytic pipeline is analyzed to identify suspicious features that include a combination of the classified features and the cluster of features. The suspicious features are annotated from the cyber threat information thereby highlighting risk and threat, and attack techniques are identified using existing domain expertise encoded as heuristics to provide additional machine learning features.

In another general embodiment, a computer-implemented method for training a machine learning model to assist a search for suspicious features includes training a model according to a set of suspicious features identified according to suspicious behavior criteria. In addition, a second set of suspicious features are identified during a federated search of a system and/or a third set of suspicious features are identified during an incident investigation of a data source. The second and/or third set of suspicious features are applied to the model for training the model to identify the second and/or third set of suspicious features during data exploration. The method includes using the model trained with the set of suspicious features identified according to the behavior criteria, the second set of suspicious features, and/or the third set of suspicious features during data exploration for identifying suspicious features. In addition, the method includes repeating the operations of identifying sets of suspicious features and training the model therewith for training the model incrementally during the data exploration.

A list of acronyms used in the description is provided below.

| | |
|---|---|
| AI | artificial intelligence |
| ASIC | application specific integrated circuit |
| ATT&CK | adversarial tactics, techniques, and common knowledge |
| CD-ROM | compact disc read-only memory |
| CP4S | Cloud Pak for Security |
| CPP | computer program product |
| CPU | central processing unit |
| CP4S | Cloud Pak for Security |
| CTI | cyber threat information |
| DVD | digital versatile disk |
| EDR | endpoint detection and response |
| EPROM | erasable programmable read-only memory |
| EUD | end user device |
| FPGA | field programmable gate array |
| GPU | graphics processing unit |
| HDD | hard disk drives |
| IC | integrated circuit |
| I/O | input/output |
| IOC | indicators of compromise |
| IoT | Internet of Things |
| LAN | local area network |
| MDR | managed detection and response |
| ML | machine learning |
| NFC | Near-Field Communication |
| NVM | nonvolatile memory |
| RAM | random access memory |
| ROM | read-only memory |
| SAN | storage area network |
| SD | secure digital |
| SDN | software-defined networking |
| SGD | stochastic gradient descent |
| SIEM | security and event management |
| SRAM | static random access memory |
| SSD | solid state drive |
| STIX | structured threat information expression |
| UDI | unique device identification |
| UI | user interface |
| USB | universal serial bus |
| VCE | virtual computing environment |
| WAN | wide area network |

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a machine learning model for detecting suspicious behavior of block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

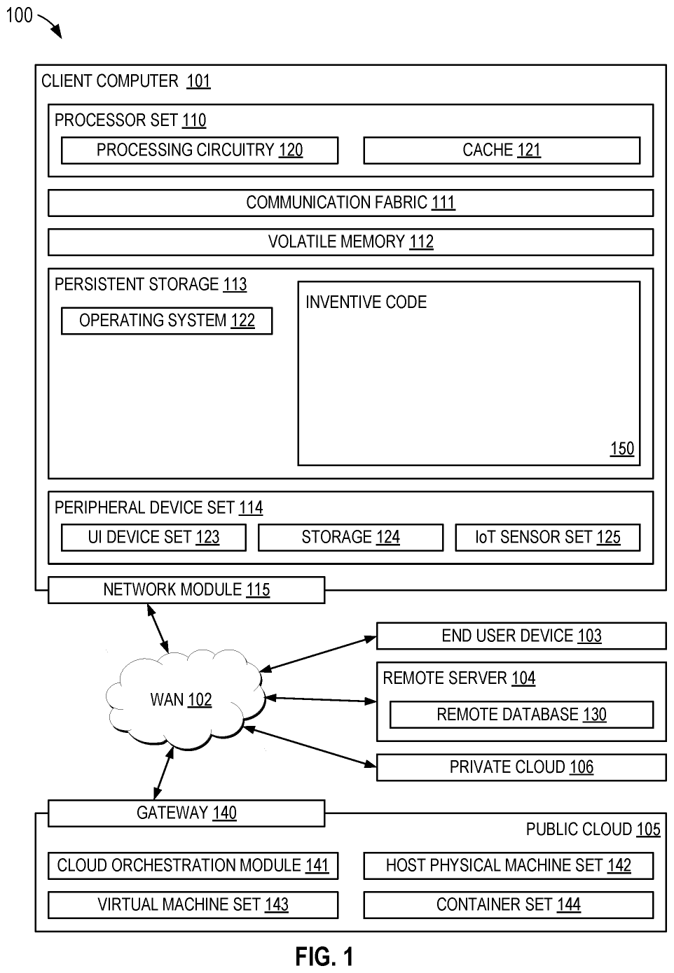

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the Internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system, according to various embodiments, may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

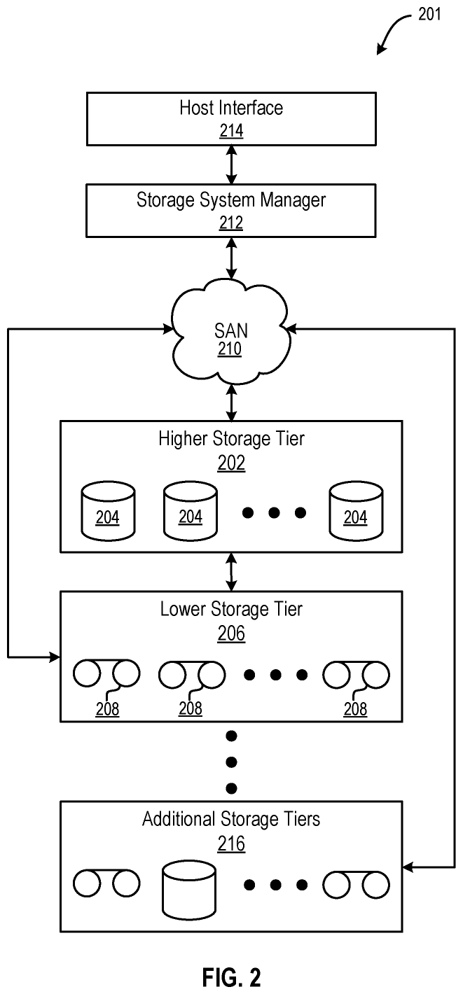

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

According to one embodiment, an online machine learning (ML) model of security threats allows security analysts and threat hunters to identify focus areas and more efficiently investigate security incidents during data exploration. A threat hunter searching for anomalous and/or suspicious behavior in a federated search environment may benefit machine learning assisted findings. The ML code may provide insights to an analyst in terms of confirming the original hypothesis and guiding the analyst to possible investigation paths (e.g., navigating rabbit holes).

A security analyst carries out reactive-type searches that include following up on an incident, creating an incident investigation, following up on a tip, etc. A threat hunter carries out proactive-type searches that include starting without prior indications of suspicious activity, searching for possible threats.

According to one embodiment, the method described herein allows application of machine learning (ML) to assist threat hunting by leveraging previous analyst experience using an incremental learning model. The ML model-based assistant helps security analysts focus on threats in an environment where data source being searched is singular or multiple, such as a federated search environment. In real time, during a federated search of a system, security analysts are able to zero in on threats over multiple data sources. Moreover, a machine learning model may be trained incrementally with threat hunter knowledge and experience during an investigation. In other words, while an investigation of a system is using the ML model to identify suspicious features, the ML model is also being trained using the insights of security threats from an analyst as well as suspicious behavior flagged according to known parameters.

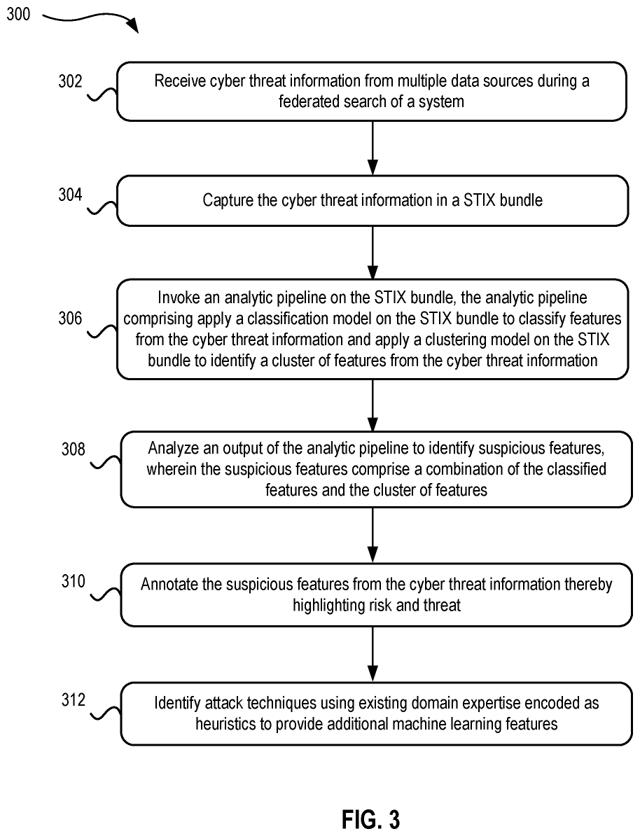

Now referring to FIG. 3, a flowchart of a computer-implemented method 300 for annotating suspicious features from federated searches using a ML model is shown according to one embodiment. The method 300 may be performed in accordance with the present invention in any of the environments depicted in FIGS. 1-7B, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 3, method 300 may initiate with operation 302, where cyber threat information (CTI) is received from a data source during a search of a system. In one approach, CTI may be received from multiple data sources during a federated search of a system. A system may be an operating system, a network, etc.

A federated search retrieves information from a variety of sources via a search engine built on top of one or more search engines in real time. A user (e.g., a threat analyst, a cyber analyst, etc.) may make a single query request (e.g., cyber threat intel, suspicious behavior, indications of compromise, etc.) that is distributed across a plurality of search engines, databases, other query engines, etc. participating in the federation. A system may be searched for security metadata across multiple data sources, and the data can be pulled out if the data matches a certain pattern, a pattern for security use cases.

The federated search then aggregates the results that are received from the search engine to be presented to the user. In one approach, a federated search may be used within a single large organization, e.g., an enterprise. In another approach, a federated search may be used for the entire web. A federated search relies on a centralized coordination of the searchable resources thereby involving both the coordination of the queries transmitted to the individual search engines and the fusion of the search results returned by each engine. In other words, a federated search provides a single point access to many information resources and returns the data in a standard or partially homogenized form. The federated search returns the security metadata from multiple data sources in a normalized form.

The federated search may include multiple data sources such as endpoint detection and response (EDR) system, security and event management (SIEM), Carbon Black, endpoint, network, file levels, etc. The threat intel may match a pattern indicative of security use cases (e.g., structured threat information expression, a standardized programming language for conveying data about cybersecurity).

In some examples, a series of incidents of suspicious behavior may include potential business email compromise, Potential Ransomware threat, etc. In particular, an important starting point for investigation may include suspicious process paths, connections, etc. An analyst using a cloud-based security process (e.g., Cloud Pak for Security (CP4S), may begin a threat analysis by pulling data from an endpoint detection and response/unique device identification (EDR/UDI) interface. Confirmation of the suspicious activity through a specific knowledge-based threat model (e.g., MITRE ATT&CK) to identification applying threat intel and asset tracking data, coupled with the domain knowledge is the expected outcome. A security analyst utilizes the search process to look for suspicious behavior, such as presence of malicious IP address, malicious command and control server connected to the infrastructure, etc.

According to one embodiment, a method is disclosed for assisted threat hunting to identify suspicious process behavior at the endpoints on the data gathered through federated search. An example of suspicious behavior includes an office application launching a power shell which in turn downloads and starts a process with obfuscated command line.

Operation 304 includes capturing the cyber threat information (CTI) in a standardized format, such as a Structured Threat Information Expression (STIX) bundle. STIX is an openly developed language for the characterization and communication of standardized CTI. The STIX bundles represent normalized data collection from endpoints.

As described herein, the method assists security analysts, threat hunters, etc. using machine learning techniques combined with an incremental training model in highlighting suspicious processes activity in STIX bundles. Operation 306 includes invoking an analytic pipeline on the STIX bundle where the analytic pipeline includes at least one ML model for identifying suspicious features in the STIX bundle. A ML model, by design and as a subset of artificial intelligence (AI), provides automatic improvement of a computer algorithm through experience. In one approach, ML algorithms build models described herein based on training data collected for classifying suspicious features and clustering suspicious features to make predictions of suspicious features without being explicitly programmed to do so.

In various approaches, the analytic pipeline includes ML models that are independent models. For example, the analytic pipeline includes a classification model and a clustering model, and each of these models are independent models. Each model is applied on the STIX bundle separately.

The ML models of the analytic pipeline may include a supervised ML model that relies on labeling data which is fed into the algorithm that includes the desired solution. A supervised system maps an input to an output based on supplied examples by analyzing a set of training data and a produced inferred function that can be used for mapping new examples. Each model uses a stochastic gradient descent (SGD) algorithm that determines the model parameters that correspond to the best fit between predicted and actual outputs.

Alternatively, the ML models of the analytic pipeline may include an unsupervised ML model that does not rely on training data, but rather uses machine learning algorithms to analyze and cluster unlabeled datasets. The algorithms may discover hidden patterns or data groupings without human intervention.

The analytic pipeline may include applying a supervised ML classification model on the STIX bundle to classify features from the CTI. The classification model allows the data to be normalized and classified to identify features representative of suspicious features. The classification model includes a classification algorithm for identifying suspicious and/or not suspicious features. The classification model may be able to identify suspicious features by analyzing relationships between features.

The analytic pipeline may include applying an unsupervised ML clustering model on the STIX bundle to identify a cluster of features from the CTI. The clustering model may include a predefined clustering algorithm for identifying features. The predefined clustering algorithm may include a combination of clustering approaches, such as anomaly identification using distance function (e.g., Kmeans for clustering), anomaly detection based on a forest method, and hierarchical density-based clustering.

In various approaches, invoking the analytic pipeline may be implemented on a cloud. In one approach, the analytic pipeline may be invoked on a hybrid cloud, e.g., a cloud pak. In another approach, the analytic pipeline may be invoked on a public cloud, e.g., such as renting space through cloud computing. In yet another approach, the analytic pipeline may be invoked within the private data center, such as a private cloud (e.g., a cloud-prem).

Operation 308 includes analyzing an output of the analytic pipeline to identify suspicious features, where the suspicious features include a combination of the classified features identified from the ML classification model and the cluster of features identified from the ML clustering model.

Operation 310 includes annotating the suspicious features from the CTI thereby highlighting risk and threat. In one approach, CTI received from the federated search includes threat intel and asset information database that may have suspicious features annotated to highlight risk and threat.

Operation 312 includes identifying attack techniques using existing domain expertise encoded as heuristics to provide additional ML features.

In various approaches, the method may be implemented on a cloud. In one approach, the method may be implemented on a private cloud. In another approach, the method may be implemented on a public cloud. In yet another approach, the method may be implemented on a combination thereof, such as a hybrid cloud.

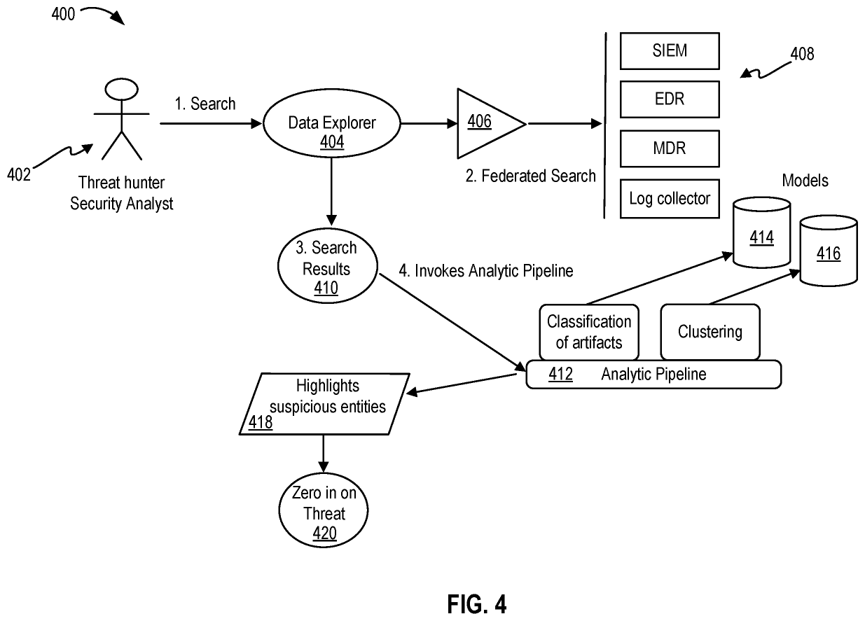

FIG. 4 depicts a schematic diagram of a system 400 that describes an artificial intelligence (AI)-assisted security data exploration on federated search, in accordance with one embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

As illustrated in FIG. 4, the system 400 discloses a method of applying machine learning to assist threat hunting leveraging previous analyst experience achieved through incremental learning model. The starting point may include the threat hunter 402 initiating data exploration 404 that includes a federated search 406 for indicators of compromise (IOCs) and collecting endpoint detection and response (EDR) data dumps 408.

In some approaches, the system 400 may be initiated in response to a prompt from a user. For example, a threat hunter, security analyst, etc. may press a button to trigger the method, such as an insights button.

Observations are captured in STIX bundles 410 from multiple data sources 408 including SIEM, EDRs such as Carbon Black, managed detection and response (MDR), Log collector, etc.

The system 400 includes invoking the analytic pipeline 412 on the STIX bundle 410. As illustrated in FIG. 4, an analytic pipeline 412 may include multiple supervised and unsupervised ML models 414, 416 (e.g., SGD classifiers) that are applied on a set of features extracted from the STIX bundles 410. The supervised ML SGD classifiers, i.e., ML models, may include a classification model 414 for classification of artifacts, features, etc. and a clustering model 416.

For example, in one approach, the system 400 includes augmenting the unsupervised ML clustering models 416 by ensemble clustering technique on the STIX bundle 410 resulting from a federated search 406. The classification models 414 may be trained with prior observation based on features that capture behavior as described further below.

The suspicious features from the STIX bundles 410 are identified in the analytic pipeline 412 are annotated in order to highlight suspicious threat entities 418. In turn, the threat hunter, security analyst, etc. is able to zero in on the threats 420.

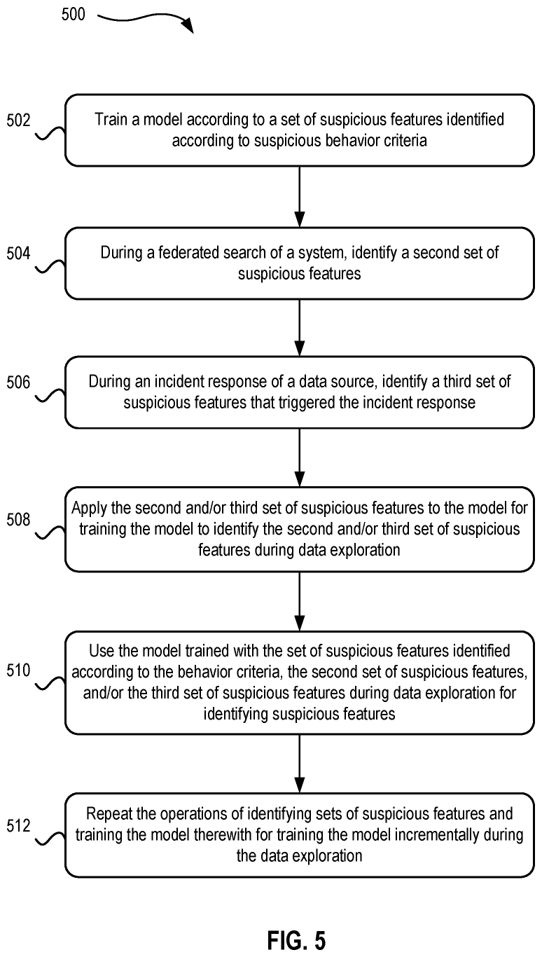

The ML model (e.g., SGD classifier) may be trained incrementally during the exploration or during an incident investigation by the security analysts. Now referring to FIG. 5, a flowchart of a method 500 for training a ML model to assist a search for suspicious features is shown in one embodiment. For example, a ML model is trained to assist a threat analyst searching for suspicious behavior. The method 500 may be performed in accordance with the present invention in any of the environments depicted in FIGS. 1-9, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where a model is trained according to a set of suspicious features identified according to suspicious behavior criteria. The set of suspicious features includes indicators of compromise (IOCs). The behavior criteria may include suspicious features defined according to a user. For example, the behavior criteria may include suspicious features defined according to the security analyst, threat hunter, etc.

In some approaches, the behavior criteria include identification of outlier characteristics such as: activity, frequency, and network connection count. For example, behavior criteria may include identification of higher entropy of a command line, network connections opened by the process, higher number of external network connections, frequency of modifications, child-count, etc.

The ML model is trained incrementally during data exploration of a federated search of a system. The ML model is continually being updated with characteristics of new identified suspicious features. Operation 504 includes identifying a second set of suspicious features during a federated search of a system.

Further, during an incident investigation of a data source, operation 506 includes identifying a third set of suspicious features that triggered the incident investigation. In some approaches, the model re-training is initiated by a user (e.g., a security analyst) during an incident investigation. For example, a suspicious feature alerts the security analyst to a breach of the system thereby prompting the security analyst to initiate an incident investigation. The suspicious feature may be identified by the security analyst and be included in a set of suspicious features for re-training the ML model. The ML model being incrementally trained allows another user doing a similar search, but possibly in a different context, at a different time, etc. to use the ML model that now includes the annotations for suspicious features identified during the incident investigation.

Operation 508 of method 500 includes applying the second and/or third set of suspicious features to the model for training the model to identify the second and/or third set of suspicious features during data exploration. The ML models use a stochastic gradient descent (SDG) algorithm. To enrich the dataset, certain features may also be added to the dataset such as entropy on the process command line, child count, etc. Features used in training (such as process-username, process-path, process-command line, child count, proc network connection count, process parent, frequency, etc.).

In one approach, the suspicious processes may be scored. The suspicious process score may be computed based on the following factor with a score of 1 being added for each match. The score may be complimentary to the ML model detecting of suspicious processes in the STIX bundles. The ML model searches the normalized STIX bundle for the following features, for example, and gives each feature a score:
Command lines that are obfuscated
Command lines that match known malicious binaries such as sekurlsa in a path
Higher Entropy of the command lines
Number of network connections opened by the process
Odd parent-child relations
Frequency of registry modifications
Outlier based on activity frequency and network connection count
   These features may be used as input into the ML model, used as training the ML model, etc. to highlight suspicious features. In one approach, these elements may be defined as features picked for training for classification of features.

Operation 510 of method 500 includes using the model trained with the set of suspicious features identified according to the behavior criteria, the second set of suspicious features, and/or the third set of suspicious features during data exploration for identifying suspicious features.

The model is dynamic and continuous, such that, operation 512 includes repeating the operations of identifying sets of suspicious features and training the model therewith for training the model incrementally during the data exploration.

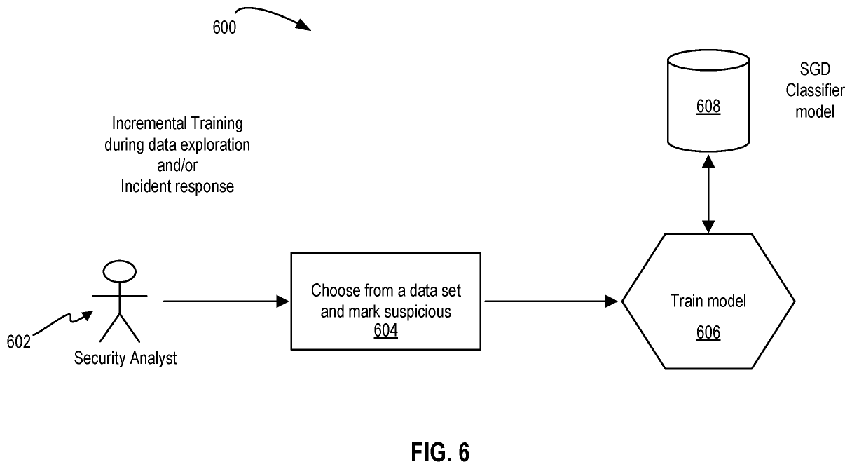

FIG. 6 illustrates a schematic diagram of a method 600 of training a ML model, according to one embodiment. A ML model is incrementally trained during data exploration and/or an incident investigation. For example, a security analyst 602 may choose, identify, etc. features from a data set and mark suspicious 604. The identified suspicious features then train the model 606 via the SGD classifier model 608. The SGD classifier model 608 is incrementally trained during the data exploration to assist system analysts, threat hunters, etc. searching other data explorations.

According to one embodiment, the training model includes a supervised ML classification model for identifying suspicious features according to a predefined classification algorithm.

In one approach, the ML clustering model may be an unsupervised ML clustering model. A training model, before being trained with training data from the ML classification model, may include the clustering output from an unsupervised ML clustering model. The output from the clustering model may be combined with the training data provided from the supervised ML classification model for annotating suspicious features.

According to one approach, the ML model may be an unsupervised ML clustering model for identifying suspicious features according to a predefined clustering algorithm. In one approach, the predefined clustering algorithm includes a combination of the following: anomaly identification using distance function (e.g., Kmeans for clustering), anomaly detection based on a forest method, and hierarchical density-based clustering.

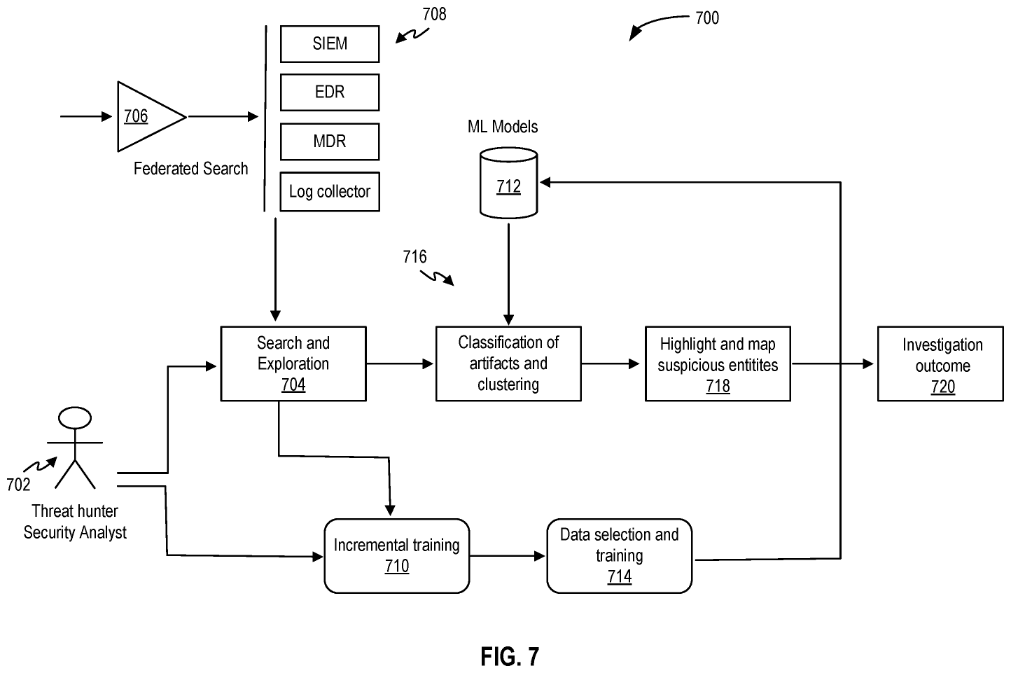

The schematic drawing of FIG. 7 illustrates the system 700 of using a ML model during data exploration in order to assist the security analyst identify and focus on security threats. A security analyst 702 (e.g., threat hunter) may initiate the capture of CTI from a search and exploration 704 during a federated search 706 of multiple data sources 708.

The security analyst 702 may also initiate and contribute to incremental training 710 of a ML model 712 for identifying suspicious features. The method of incremental training 710 may also include suspicious features identified from a search and exploration 704 during a federated search 706 from multiple data sources 708. The incremental training 710 of the ML models 712 includes data selection and training 714 of the ML models 712 concurrently as the system 700 is using the ML models 712.

The system 700 includes applying an analytic pipeline 716 to the CTI from the search and exploration 704. The analytic pipeline 716 includes applying the ML models 712, such as a ML classification model and a ML clustering model, to classify and cluster the suspicious features, respectively. Analysis of the identified, classified, and clustered suspicious features leads to highlighting and mapping suspicious entities 718. The system 700 generates an investigation outcome 720 to assist the security analyst in zeroing in on the highlighted threats.

The ML models 712 are incrementally trained and may be available online for assisting other security analysts during a federated search for security threats.

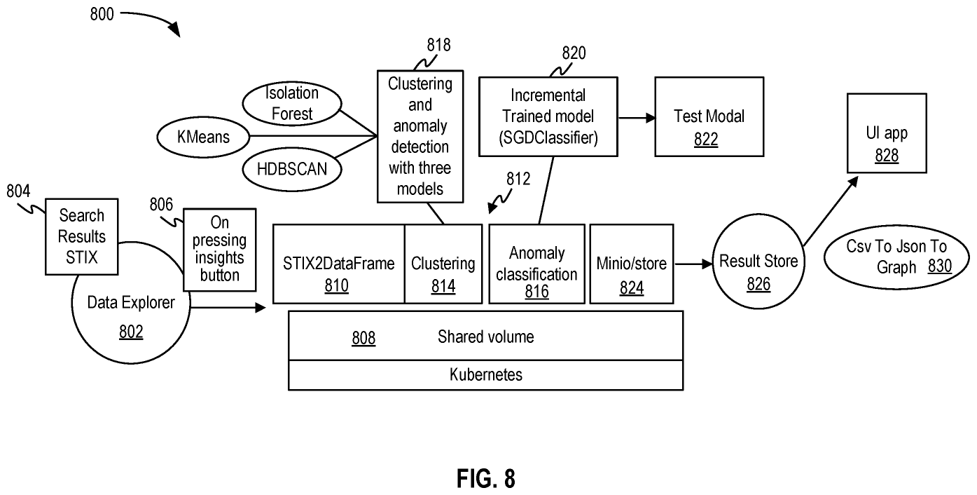

In one example, FIG. 8 is a schematic diagram that illustrates an example of implementation of a system 800 that uses the ML models to assist identification of suspicious features, according to one embodiment. A data explorer 802 includes extracted CTI captured in a STIX bundle 804. The system 800 may be triggered by a security analyst by pressing an insights button 806, upon which a shared volume 808 including the STIX bundle 804 converted to a STIX data frame 810 becomes available for the analytic pipeline 812.

The analytic pipeline 812 includes a ML clustering model 814 and a ML anomaly classification model 816 that are applied to the STIX data frame 810. In one example, the clustering technique 818 as applied in the clustering model 814 applies a combination of three clustering models. Using the first model, the algorithm determines Kmeans for clustering and then the algorithm determines anomalies using a distance function. Using the second model, an anomaly is detected based on a forest method, e.g., an Isolation forest. Using the third model, the algorithm uses HDBCAN to performs hierarchical density-based clustering to dynamically select the appropriate number of clusters.

The incrementally trained model 820, e.g., SGDClassifier, provides classification of the anomalies present in the STIX data frame 810.

The Test Model 822 may include annotated suspicious features identified by clustering and classifying in the ML models 814, 816 in the analytic pipeline 812. The Test Model 822 may be an online model available to assist other systems via the cloud.

The annotated suspicious features may be stored through a series of operations 824, 826 and user interface (UI) App 828 shows the classification and clustering output, e.g., as insights graph 830.

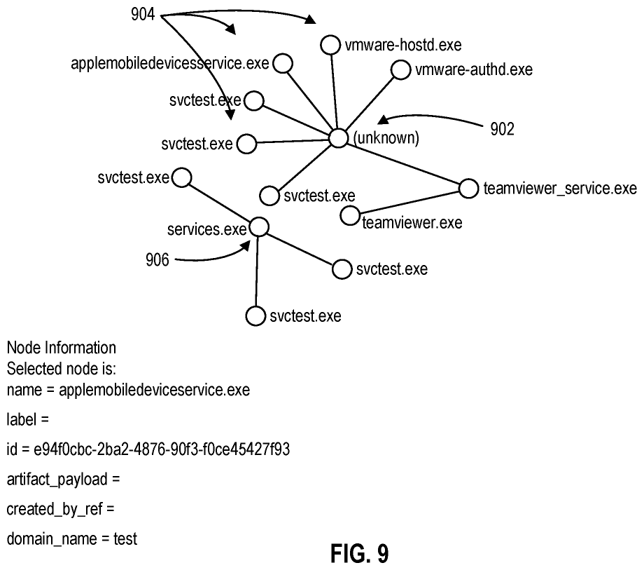

FIG. 9 illustrates an example of the result in the form of an insights graph. The diagram identifies possibly two suspicious processes. There is one process 902 using teamviewer, probably from a remote desktop connection, and it demonstrates all the different relationships 904 in a graphic relationship with different nodes that may explain why this process 902 is marked as a suspicious species. The system identifies the relationships between a suspicious process and what is noticed in that context. A second suspicious process 906 is shown with nodes and the relationships associated with this process 906 between the nodes.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving cyber threat information from a data source during a search of a system;
capturing the cyber threat information in a STIX bundle;
invoking an analytic pipeline on the STIX bundle, the analytic pipeline comprising:
applying a classification model on the STIX bundle to classify features from the cyber threat information, and
applying a clustering model on the STIX bundle to identify a cluster of features from the cyber threat information;
analyzing an output of the analytic pipeline to identify suspicious features, wherein the suspicious features comprise a combination of the classified features and the cluster of features;
annotating the suspicious features from the cyber threat information thereby highlighting risk and threat; and
identifying attack techniques using existing domain expertise encoded as heuristics to provide additional machine learning features.

2. The computer-implemented method of claim 1, wherein the cyber threat information is received from multiple data sources during a federated search of the system.

3. The computer-implemented method of claim 1, wherein invoking the analytic pipeline is implemented on a cloud selected from the group consisting of: a private cloud, a public cloud, and a combination thereof.

4. The computer-implemented method of claim 1, wherein the classification model is a supervised machine learning model.

5. The computer-implemented method of claim 1, wherein the clustering model is an unsupervised machine learning model.

6. The computer-implemented method of claim 1, wherein the clustering model and the classification model use a stochastic gradient descent (SGD) algorithm.

7. The computer-implemented method of claim 1, wherein the classification model and the clustering model are independent models.

8. The computer-implemented method of claim 1, wherein the classification model includes a classification algorithm for identifying suspicious and/or not suspicious features.

9. The computer-implemented method of claim 1, wherein the clustering model includes a predefined clustering algorithm for identifying features.

10. The computer-implemented method of claim 9, wherein the predefined clustering algorithm includes a combination of: anomaly identification using distance function, anomaly detection based on a random forest method, and hierarchical density-based clustering.

11. The computer-implemented method of claim 1, wherein the method is initiated in response to a prompt from a user.

12. A computer-implemented method for training a machine learning model to assist a search for suspicious features, the method comprising:
training a model according to a set of suspicious features identified according to suspicious behavior criteria;
during a federated search of a system, identifying a second set of suspicious features;
during an incident investigation of a data source, identifying a third set of suspicious features that triggered the incident investigation;
applying the second and/or third set of suspicious features to the model for training the model to identify the second and/or third set of suspicious features during data exploration;
using the model trained with the set of suspicious features identified according to the behavior criteria, the second set of suspicious features, and/or the third set of suspicious features during data exploration for identifying suspicious features; and
repeating the operations of identifying sets of suspicious features and training the model therewith for training the model incrementally during the data exploration.

13. The computer-implemented method of claim 12, wherein the model uses a stochastic gradient descent (SGD) algorithm.

14. The computer-implemented method of claim 12, wherein the behavior criteria include suspicious features defined according to a user.

15. The computer-implemented method of claim 12, wherein the behavior criteria include identification of an outlier characteristic selected from the group consisting of: activity, frequency, and network connection count.

16. The computer-implemented method of claim 12, wherein the model is an unsupervised machine learning clustering model for identifying suspicious features according to a predefined clustering algorithm.

17. The computer-implemented method of claim 16, wherein the predefined clustering algorithm includes a combination of anomaly identification using distance function, anomaly detection based on a forest method, and hierarchical density-based clustering.

18. The computer-implemented method of claim 12, wherein the model is a supervised machine learning classification model for identifying suspicious features according to a predefined classification algorithm.

19. The computer-implemented method of claim 12, wherein the model is trained incrementally during the data exploration of the federated search of the system.

20. The computer-implemented method of claim 12, wherein the model re-training is initiated by a user during the incident investigation, wherein the third set of suspicious features includes suspicious features identified by the user.
